(19) United States
(12) Patent Application Publication
(10) Pub. No.: US 2005/0177369 A1
(43) Pub. Date: Aug. 11, 2005

(54) Method and system for intuitive text-to-speech synthesis customization

(76) Inventors: Kirill Stoimenov, Lompoc, CA (US); Peter Veprek, Santa Barbara, CA (US); Matteo Contolini, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/776,892

(22) Filed: Feb. 11, 2004

(51) Int. Cl. G10L 13/00

(52) U.S. Cl. 704/260

(57) ABSTRACT

A system for tuning the text-to-speech conversion process having a text-to-speech engine that converts the input text into a processed text form which includes speech features. A visual editing interface displaying the processed text form using graphical indicators on an output device to allow a user to edit the text and graphical indicators to modify the speech features of the text input.

### FIELD OF THE INVENTION

The present invention generally relates to speech synthesis and in particular to the tuning of the text-to-speech conversion process.

### BACKGROUND OF THE INVENTION

Communicating with computers using speech as a medium remains an open-ended pursuit for the research community. Flawless speech-to-speech communication between a user and a computer remains a long-term goal. At present, however, text-to-speech conversion is one area of speech synthesis that has received considerable commercial attention. In such text-to-speech conversion process, a user supplies text as an input to a computer, and then the computer outputs a speech equivalent to the entered text in a spoken (audio) form. Typically, a software engine drives the process of converting text-to-speech. The actual audio is produced by using widely available sound-cards.

Several applications that process routine user-queries or make announcements use the technique of text-to-speech conversion. For example, announcements within trains or on train-stations, searching a company telephone directory, querying bank account balances, announcing waiting-times in a dynamic manner, etc. A popular use of text-to-speech systems is in call-center operations. While a large number of text-to-speech conversion systems are used in the telephone-based query setup, other non-telephone based applications also exist. Customization of the text-to-speech systems for various applications is described next.

Text-to-speech conversion, though automatic in operation, can require customization depending upon the needs of a given application. For example, in a typical telephone based bank-account query system that informs the account holder about the current balance of an account, the system must pronounce the balance information precisely and slowly. However, in other text-to-speech systems, such as a phone-based airport information query system, it would be desirable to have the system quickly announce the list of all delayed flights on a given day to avoid long wait-times for other callers. In other words, the text-to-speech process needs to be customized, depending upon the requirements of the particular application, either to produce fast or slow-paced speech output. The pace of speech output is but one of many parameters of the text-to-speech conversion systems that need to be customized. Hence, there is a need for a customizable or a tunable text-to-speech conversion system.

A typical way of customizing a text-to-speech system is to manually insert control tags or commands in the text input file that is fed to a text-to-speech conversion engine. The control tags will typically modify the speech output in a number of ways such as pronouncing certain words fast or slow, controlling the pause interval between selected words, etc. However, this approach presents several problems. First, customization of input text with control tags will require a person of considerable training to insert the control tags in the text input at proper places to achieve the required speech modulation. Second, entering control tags intermingled with the basic text is a non-intuitive and certainly not a user-friendly way of modifying the speech output. Third, even for a person of considerable training, it will be inefficient to edit the text file, edit the control tags, listen to the output, and repeat the process until the required output is achieved. Hence, there is a need for a user-friendly technique for modulating the speech output produced by a text-to-speech conversion system.

### SUMMARY OF THE INVENTION

A system for tuning the text-to-speech conversion process is described. The system includes a text-to-speech engine that converts the input text into a processed form of Parameterized Aligned Sound Records (PASR) format. The PASR format includes speech features of the text input. A visual editing interface displays the text with speech features being represented as visual indicators such as font, color, spacing, bold, italic, etc. The user can edit the text and the visual indicators to modify the underlying speech features of the text. The user can generate the speech audio to test the text-to-speech conversion, and repeat the editing-testing process till a desired speech output is achieved. User can save the processed text in a database and retrieve the same later on.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a system overview diagram for the visual tuning of text-to-speech conversion process employed in the present invention;

FIG. 2 shows a representation of the PASR format conversion process.

FIG. 3 shows an exemplary GUI editor;

FIG. 4 is a graphical representation of the design of the visual tuning system according to the principle of the present invention; and

FIG. 5 shows the relation between the design of the tuning system and the GUI editor.

### DETAILED DESCRIPTION OF THE PREFERRED EMBODIMENTS

The following description of the preferred embodiment(s) is merely exemplary in nature and is in no way intended to limit the invention, its application, or uses.

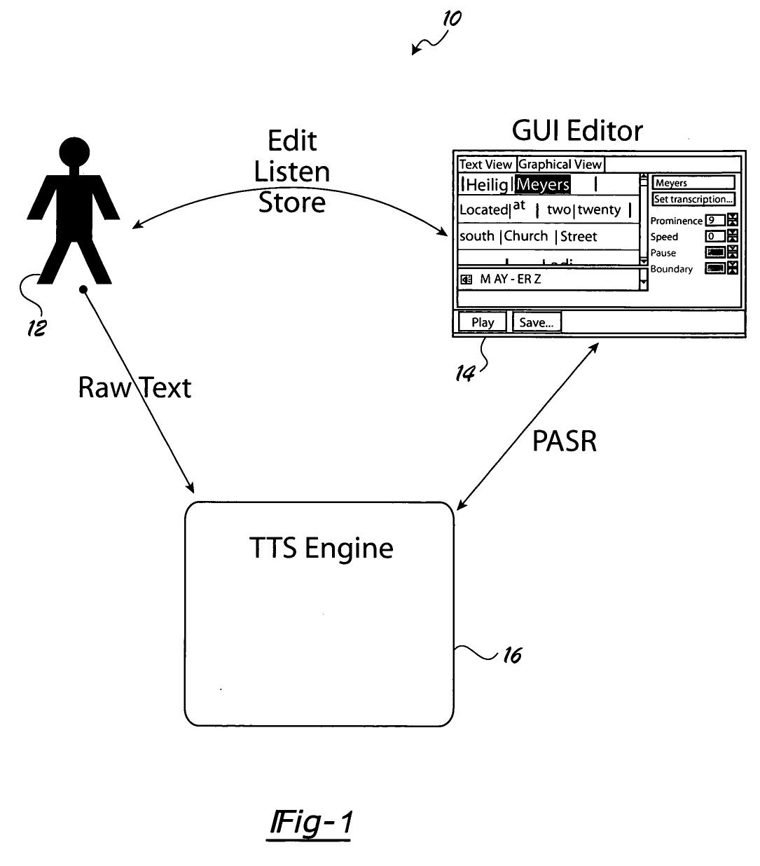

FIG. 1 is a system overview diagram for the visual tuning of the text-to-speech conversion process employed in the present invention. The Visual Text-to-Speech (TTS) tuning system 10 starts the tuning process with a user 12 supplying raw text, e.g., ASCII or Unicode encoded text, to a TTS engine 16. The raw text is plain simple text without any speech modulation tags or commands. The raw text can be entered either through a Graphical User Interface (GUI) for entering text (not shown) or as a simple text file. The user 12 can supply raw-text to the TTS engine 16 by using any available technique. Those skilled in the art will appreciate that the manner or format in which the user 12 supplies raw text to the TTS engine 16 does not limit the invention. The interaction of the TTS engine 16 and a GUI editor 14 is described next.

The TTS engine 16 receives the raw text from the user 12 and converts it internally to normalized text, because the input text can contain some unpronounceable characters or terms like dates, dollar amounts, etc. The TTS engine 16 includes a module called text normalizer (not shown) that expands unpronounceable character strings into pronounceable words. For example, the text normalizer will expand the string “10/25/1995” to the string “october twenty fifth nineteen ninety five”. The output of the normalizer is called normalized text and each word from the normalized text is a normalized word. After converting the input text into normalized text the PASR format of the input text is generated by the TTS engine 16. PASR format is the processed representation of the input text that will be used by the GUI editor 14.

The user 12's interaction with the GUI editor 14 is described next. The GUI editor 14 displays the PASR data received from the TTS engine 16. The displayed data inside the GUI editor 14 includes visual representation of speech features as described in detail further below. The user 12 views the PASR data in the GUI editor 14 and then repeats the cycle of editing and listening until the desired audio reproduction of the text-to-speech conversion is achieved. Thereafter, the user 12 can choose to store the edited text in the GUI editor 14.

The TTS engine 16 produces a particular type of speech output that is more suitable to visual editing. The TTS engine 16 reports the origin of the transcription to the GUI editor 14. Hence, the GUI editor 14 can determine if a particular transcription of the word is the result of the TTS engine 16's processing or if it was supplied by the user. The phonetic transcription is a string of the phonemes that specify how the word should be pronounced. For example, for the word “ghost”, one possible transcription will be “g ow s t”. For example in some dialects of English the word “news” can be pronounced as “n uw z”, in some others as “n y uw z”. For the purposes of illustration, it is assumed that the default transcription is “n uw z” and that a user has supplied a user-defined transcription “n y uw z” for that word. The TTS engine 16 will recognize the user-defined transcription and will report to the GUI editor 14 the origin as defined by the user. The text will be synthesized according to the user's transcription, with the word “news” being pronounced as “n y uw z”. The details of the GUI editor 14's structure and function are described next

PASR format includes the normalized text produced by the TTS engine 16. It also includes aligned with the normalized text, the TTS parameters which were used to generate the synthesized sound. The PASR format can accommodate parameters for each normalized word and word-boundary. For each normalized segment like a word in text, properties that can be associated with graphic indicators are synthesized speech, normalized text, phonetic transcription, prominence and relative speed. Synthesized speech is the audible representation of the word in some popular sound format. For example, the sound format can be PCM, 11 Khz, 16-bit, mono. Prominence denotes how important a particular word is in a given sentence. Usually, the higher prominence value is, the greater is the energy, the longer is the duration and the greater is the pitch variation that are associated with it. For each boundary the properties that can be associated with graphic indicators are synthesized waveform, boundary strength and pause length. Hence, within the PASR format each word or word-boundary can be displayed and modified in an independent manner.

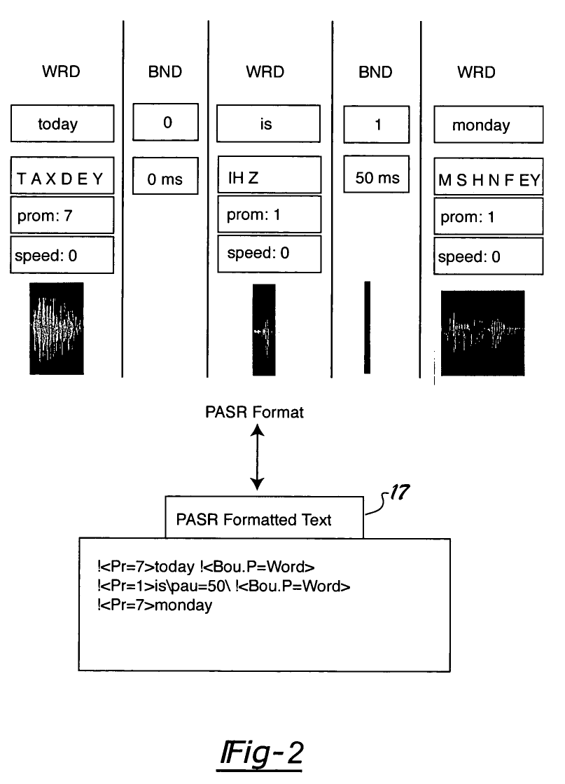

FIG. 2 shows a representation of the PASR format conversion process. The interface between the GUI editor 14 and the TTS engine 16 is implemented via PASR formatted text 17 as the TTS engine 16's input and PASR data as the TTS engine 16's output. PASR formatted text 17 is the textual representation of the PASR data, which can be directly generated from the PASR data by writing out the properties associated with each individual word or boundary into a text string using the TTS tag format.

The PASR formatted text 17 can be passed through the TTS engine 16 multiple times without any change caused by the TTS engine 16, unlike the raw text that can undergo modification when passed through the TTS engine 16. This transitive closure guarantees that the PASR formatted text will stay unchanged irrespective of the number of times it is passed through the TTS engine. Therefore, the PASR formatted text can be stored in a database and can be used to regenerate the same sound. Further, text edited through the GUI editor 14 can be used to generate a waveform by using a different TTS engine (not shown) that uses the same tag format as the TTS engine 16. Hence, the TTS engine 16 generates PASR data and supplies it as an input to the GUI editor 14.

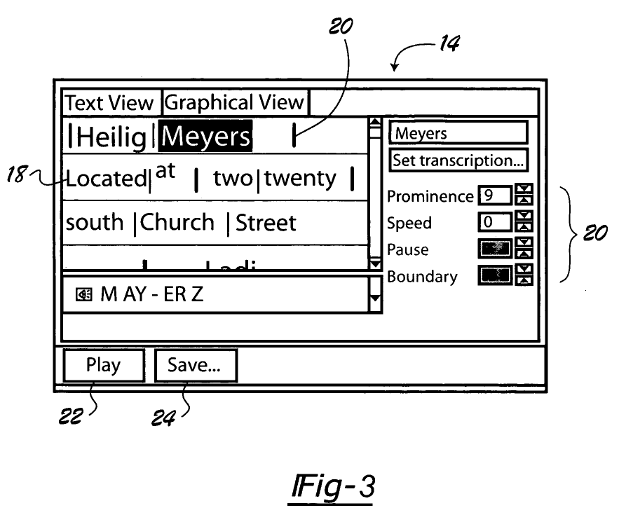

FIG. 3 shows an exemplary GUI editor 14. The system 10 provides a tool that functions like visual interface to the TTS engine. The visual interface tool provides multi-channel communication with the TTS engine, the communication between the TTS engine and the tool being carried out through the PASR format. The capabilities of the visual interface tool are defined and determined by those of the TTS engine. The GUI editor 14 is an example of such a visual interface tool and is described next in detail.

The GUI editor 14 is typically in a window form. The GUI editor 14 can be organized or designed in multiple ways. Those skilled in the art will readily recognize that the GUI editor 14 shown here is merely an example and does not limit the invention in any way. The GUI editor 14 can display words 18 and word boundaries 20. Each one of the words 18 can have independent display characteristics. For example, a word can be displayed at a greater height and with a smaller font to display visually the emphasis in pronunciation that has to be used when converting it to a speech form. The user 12 (see FIG. 1) thus can use the GUI editor 14 to fine-tune the text-to speech synthesis process in an interactive manner.

The GUI editor 14 operates independent of the language of the text. The language specific operations are carried out by the TTS engine. Hence, the same GUI editor can be used for different languages by just replacing or modifying the TTS engine for a particular language.

The visual tuning approach of the present invention eliminates the need for the user 12 (see FIG. 1) to have any special training or experience in the speech synthesis process. The user 12 can interactively control the pronunciation of each word and the pauses between words, among other features of the speech, to be produced from the text. Further, the present invention eliminates the need for the user 12 to know or remember any specific tags or commands to control the speech synthesis process because all required speech parameters can be modified visually. Hence, a system that can be operated by any user without any special training can provide significant savings in cost of customizing a text-to-speech synthesis system.

Typically, controls can be included in a control-box 20 where specific values for prominence, speed, pause and boundary can be entered and modified. While the user can always modify the words 18 using a pointing device like a mouse or a track-ball, the control-box 20 provides an additional way to precisely enter values for speech parameters. Other functions like play 22 (to generate sound output) and save 24 (to save the sound output) can be included in the GUI editor 14.

A user can control, edit and test multiple speech features or parameters that are represented in a graphical form using graphical indicators or features of a GUI. For example the following features and parameters can be tuned or adjusted: normalized (expanded) text, part-of-speech assignment, parsing of the text, chunking of the text, boundary strength, pause duration, phonemic and/or allophonic transcription including stress and syllabification, speech rate, syllable or segment duration, pitch (default, minimum, maximum, actual contour), word prominence, or emphasis, formant mixing mode (linear or logarithmic), unit selection override, intensity contour, formant trajectories, and allophone rules (turned on or off). Those skilled in the art will appreciate that the above listed speech features are merely examples of the visually tunable features of speech and the same do not limit the present invention.

Typically for each word in the text allophonic transcription (pronunciation), prominence (intonation), and speed (speech rate) can be customized by the user using the visual editing interface. Further, between-the-words parameters such as pause-length and prosodic boundary strength can be customized. Typically, the graphical editing interface can be designed to edit the speech features on a word level. However, there is no such requirement and editing can be performed at other levels. For example, at the allophonic level or even by using continuous envelope curves like Bezier curves.

A variety of graphical indicators or features can be used to represent speech features listed above in the text output within the GUI editor 14. For example speech features can be represented using variations in font faces; coloring of text; vertical and horizontal spacing between words and individual letters of the words; styles such as italic, bold, underlined, blinking and crossing-out; orientation of the text, rotation of text, punctuation etc. Any of these or other graphical indicators can be used either individually or in combination to potentially produce a large set of graphical indicators that can be associated with the speech features for displaying in the GUI editor 14. Those skilled in the art will appreciate that the above examples of graphical indicators are mere illustrations and hence do not limit the invention in any manner.

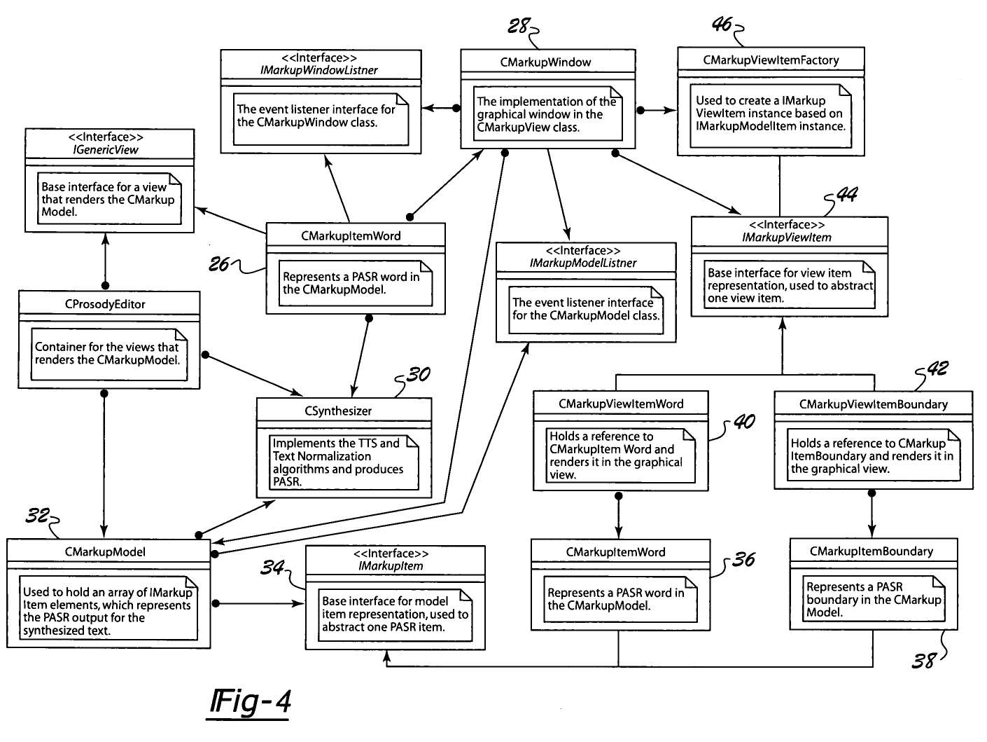

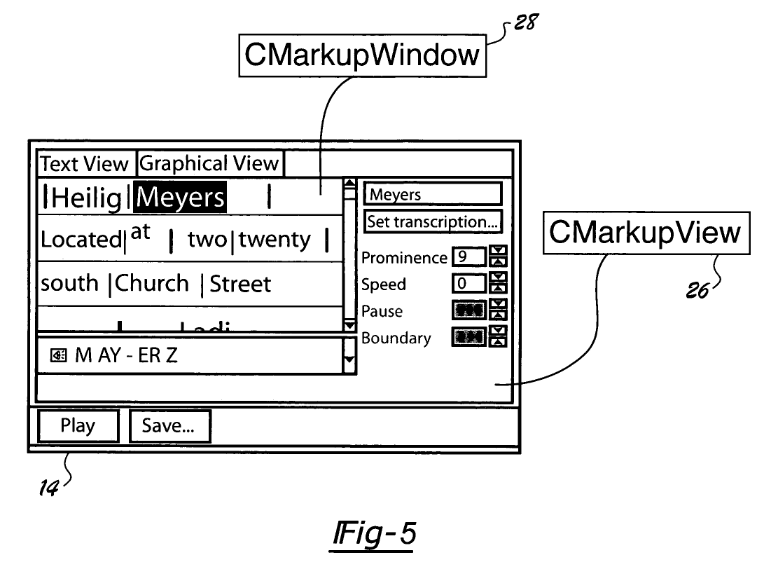

FIG. 4 is a graphical representation of the design of the visual tuning system according to the principle of the present invention. FIG. 5 shows the relation between the design of the tuning system and the GUI editor 14. An example of the GUI editor 14's design is described next. CMarkupview class 26 is the basic class for displaying the text in a graphical form. Another class CMarkupWindow 28 shows the window inside the CMarkupview class 26's overall display area. Classes CSynthesizer 30 and CMarkup Model 32 form the PASR text input to the CMarkupView 26 class. An interface IMarkupItem 34 abstracts one PASR text item and is related to the CMarkupModel class 32, which holds the PASR output of the synthesized speech.

The IMarkupItem interface 34 is related to a CMarkupItemWord class 36 that represents a single word 18 (see FIG. 2); while a CMarkupItemBoundary class 38 represents a PASR boundary, i.e., a word boundary. Classes CMarkupViewItemWord 40 and CMarkupViewItemBoundary 42 refer to the CMarkupItemWord class 36 and the CMarkupItemBoundary class 38 and render graphical representations of a word and boundary. Interface IMarkupViewItem 44 is the base interface to abstract one item for view that can be either a word or a boundary. CMarkupViewItemFactory class 46 is used to create multiple instances of view items like words and boundaries that are then supplied to the CMarkupWindow class 28. The design includes other supporting classes that are listeners for trapping and processing events in the visual classes. Those skilled in the art would appreciate that the above design is merely an example of structuring a visual tuning system according to the principle of the present invention.

FIG. 4 shows the graphical view of the basic classes in the design of the visual tuning system. The CMarkupView class 26 is the overall view of the GUI editor 14 that performs the visual editing functions. The CMarkupWindow class 28 represents the main graphical region for displaying text with sound features represented as visual variations.

In the visual tuning approach of the present invention, the user can easily experiment with different speech parameters in a graphical and intuitive manner and then select the best combination of speech parameters for a given application. The above listed speech parameters are just examples of various speech parameters that can be visually tuned. Hence, those skilled in the art will appreciate that the above examples of speech parameters do not limit the invention in any manner.

Under the visual tuning approach of the present invention, the changes in the sound of the text to be converted into speech are psychologically related to the graphical properties of the text shown in the GUI editor 14. For example, the graphical length of the word is related to the duration of pronunciation. The longer the graphical representation of a given word 18, the longer will be the sound of the word. The relative vertical position of a given word 18 represents the prominence of the word. In a similar manner, many other graphical properties can be associated with other speech parameters. Those skilled in the art will appreciate that the above examples of relating graphical properties of displayed text and the sound produced by such text are merely examples and hence do not the limit the present invention.

The present invention can be incorporated in a software, hardware or combination of software and hardware forms. For example, the visual tuning interface can be designed as an ActiveX control. Further, two windows can be provided, where one window is used to enter the text and the other window functions as the GUI editor 14 (see FIG. 3). A client-server model can be also be used. For example, the GUI editor 14 can be run on a client like a cellular phone or a handheld PDA and the TTS engine can be executed on a server. Those skilled in the art will appreciate that the particular configuration of the GUI editor 14 can be adapted for any particular application, and the same does not limit the invention in any manner.

The principle of the present invention can be applied to various application of the invention. For example, the visual tuning control according to the principle of the present invention can be used to customize a car-navigation system. In such a system, the GUI editor 14 (see FIG. 3) has a set of fixed text messages with blank slots that are editable. The user can enter text to be pronounced in the blank slots, but not modify the other fixed text. The user can visually modify a limited number of text parameters to control the speech output, for example, the speed or pauses. Hence, a car-navigation system that uses speech prompt can be easily built and customized even by a user who is not trained in text-to-speech conversion process.

The description of the invention is merely exemplary in nature and, thus, variations that do not depart from the gist of the invention are intended to be within the scope of the invention. Such variations are not to be regarded as a departure from the spirit and scope of the invention.

1. A system for tuning the text-to-speech conversion process, the system comprising:
a text-to-speech engine, said text-to-speech engine receiving at least one text-input and converting said text-input into a processed representation,
said processed representation including at least one speech feature associated with at least one segment of said representation; and
a visual editing interface, said visual editing interface displaying said processed representation using at least one graphical indicator on an output device, wherein said segment is displayed on said output device using said graphical indicator corresponding to said speech feature.

2. The system of claim 1 wherein said visual editing interface provides at least one editing function to a user, the editing function enabling the modification of said speech feature associated with said segment through a change in the corresponding said graphical indicator.

3. The system of claim 2 wherein said visual editing interface associates said speech feature corresponding to said segment with said graphical indicator, wherein the user's modification of said graphical indicator results in a corresponding change in said speech feature of said segment.

4. The system of claim 1 wherein said speech feature is at least one of the following: normalized text, part-of-speech, parsing of text, chunking of text, boundary strength, pause duration, transcription, speech rate, syllable duration, segment duration, pitch, word prominence, emphasis, formant mixing mode, unit selection override, intensity contour, formant trajectories, and allophone rules.

5. The system of claim 1 wherein said graphical indicator comprises at least one of the following: graphical style, font faces, coloring, vertical spacing, horizontal spacing, italicization, boldness, underlining, blinking, crossing-out, text orientation, text rotation, punctuation symbols and graphical symbols.

6. The system of claim 1 wherein said processed representation employs a parameterized aligned sound records format.

7. The system of claim 1 wherein said segment comprises at least one of the following: word, letter, syllable, pause, word boundary and punctuation-mark.

8. The system of claim 1 wherein said visual editing interface operates as a plug-in for a graphical user interface.

9. The system of claim 8 wherein said plug-in is an ActiveX control.

10. The system of claim 1 wherein said visual editing interface allows editing of said input-text wherein said input-text contains at least one non-editable said text segment and at least one editable said segment.

11. The system of claim 1 wherein said visual editing interface is language independent.

12. The system of claim 1 wherein said visual editing interface provides the user with speech audio output of said processed representation.

13. The system of claim 1 wherein visual editing interface is connected to a data-store for storing and retrieving said representation.

14. The system of claim 1 wherein the said processed representation is a textual representation.

15. The system of claim 14 wherein the said textual representation is used to generate said processed representation.

16. The system of claim 15 wherein said textual representation is stored and accessed from a data store.

17. The system of claim 14 wherein said textual representation is used to generate synthesized speech using a TTS system distinct from said text-to-speech engine.

18. A system for providing a text-to-speech interface, the system comprising:
a visual interface connected to a text-to-speech engine; and
at least one communication channel connecting said visual interface to said text-to-speech engine, said text-to-speech engine communicating with said visual interface over said communication channel by sending and receiving at least one data segment in a format.

19. The system of claim 18 wherein said format of said data segment is a parameterized aligned sound records format.

20. The system of claim 18 wherein said text-to-speech engine sends said data segment in the parameterized aligned sound records format to said visual interface, said visual interface rendering said data segment in a visual form, said visual interface allowing editing of said data segment to produce an edited data segment, said visual interface sending said edited data segment to said text-to-speech engine.

21. The system of claim 18 wherein said visual interface sends data to said text-to-speech engine over a first said communication channel and said text-to-speech engine sends data to said visual interface over a second said communication channel.

22. A method for visual tuning text-to-speech conversion process, the method comprising:
converting an input-text to a processed representation using a text-to-speech engine, said processed representation including at least one speech feature of said input-text;
displaying said processed representation on a visual editing interface connected to said text-to-speech engine, said speech feature of said processed representation being displayed in a corresponding graphical form; and
providing an editing function in said visual editing interface to a user for modifying said speech feature in said graphical form.

23. The method of claim 22 further comprising:
generating speech audio equivalent of said processed representation through said visual editing interface.

24. The method of claim 22 further comprising:
saving said processed representation in a data store; and
loading said processed representation stored in said data store into said visual editing interface.

25. The method of claim 22 further comprising:
converting said processed representation into a textual representation.

26. The method of claim 25 further comprising:
converting said textual representation into a processed representation.

27. The method of claim 25 further comprising:
storing said textual representation in a data store; and
loading said textual representation stored in said data store into said visual editing interface.

28. The method of claim 25 further comprising:
using said textual representation to synthesize speech using a TTS system distinct from said text-to-speech engine.
